(19) United States
(12) Patent Application Publication
(10) Pub. No.: US 2014/0121891 A1
(43) Pub. Date: May 1, 2014

(54) AUTOMOBILE DATA ABSTRACTION AND COMMUNICATION

(71) Applicant: CLOUDCAR, INC., Los Altos, CA (US)

(72) Inventors: Peter Barrett, Palo Alto, CA (US); Konstantin Othmer, Los Altos, CA (US); Bruce Leak, Los Altos Hills, CA (US)

(73) Assignee: CLOUDCAR, INC., Los Altos, CA (US)

(21) Appl. No.: 13/664,212

(22) Filed: Oct. 30, 2012

(51) Int. Cl. G06F 7/00

(52) U.S. Cl. 701/33.2

(57) ABSTRACT

Communication of signals between mobile devices and automotive Controller Area Network (CAN) buses. An abstraction and communication device includes a connector, a mapping platform, and a transceiver. The connector is adapted to interface with an automotive CAN bus that communicates data signals in a first automobile-specific format with components of an automobile. The mapping platform is configured to convert a data signal from the first automobile-specific format into a mobile device format defined by an Application Programming Interface (API). Additionally, the transceiver is configured to wirelessly and securely communicate the data signal in the mobile device format to a mobile device.

### BACKGROUND

1. Field of the Invention

Embodiments of the invention relate to communication of signals between mobile devices and Controller Area Network (CAN) buses.

2. Related Technology

As the complexity of mechanized systems such as automobiles, industrial equipment, and medical equipment increases, the variety and utility of systems and devices that electronically interface with components included in the mechanized systems has also increased. For example, since the 1980s, most new automobiles include Electronic Control Units (ECUs), which are increasing in number in new vehicles each year. For instance, a Powertrain Control Module (PCM) is an ECU associated with an automobile engine. An ECU typically includes a microprocessor that receives input from sensors associated with a particular automobile subsystem and has software and hardware that allows components of the subsystem to be controlled.

ECUs communicate with each other and with other components of the automobile using one or more Controller Area Network (CAN) buses. For example, a PCM is capable of communicating over a CAN bus to control automatic transmissions, traction control systems, and other systems in the automobile. In general, the CAN bus is a multi-master broadcast serial bus that transmits data between ECUs. Modern automobiles also include an On Board Diagnostics (OBD) connector, such as those defined by the OBD II specification, that enables CAN bus to be accessed. The OBD connector can thereby permit diagnostics information to be accessed and to enable software in ECUs in communication with the CAN bus to be upgraded. Many ECUs and associated data are proprietary to a particular automobile or subsystem manufacturer as opposed to being defined by industry standards.

Some devices include electronically interfacing components or devices that interface with systems outside the device. The interfacing components or the systems outside the device may differ in software languages, data formats, protocols, addressing schemes etc. The differing software languages, data formats, protocols, and addressing schemes may result in incompatibility between the interfacing components or between the device and the systems outside the device, and make it difficult for outside systems to interface with these systems. To enable communication between interfacing components or between the device and the systems outside the device, an Application Programming Interface (API) may be developed. An API generally includes one or more specifications, which communicate information pertaining to program routines or sub-routines, structure or organization of data, classes of objects, and functions of variables. The API may include libraries of programming languages, standards, or documentation published by a vendor.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF SOME EXAMPLE EMBODIMENTS

Embodiments discussed herein generally relate to communication of signals between mobile devices and Controller Area Network (CAN) buses. In one example embodiment, an automobile user can use a mobile device to communicate with the CAN bus and Electronic Control Units (ECUs) associated therewith. The data signals generated or received on the CAN bus may be further received at the mobile device and then processed at the mobile device in a variety of mobile device applications. Write signals may also be transmitted from the mobile device to the CAN bus to control or alter various components of the automobile. The write signals transmitted to the CAN bus may alter various components, resulting in an improved driving experience, improved fuel efficiency or safety, or accessing automobile performance information, for instance.

According to embodiments described herein, an automotive data abstraction and communication device (abstraction device) includes a connector configured to be connected to, for example, an OBD II connector associated with the CAN bus. The abstraction device abstracts information regarding the ECU hardware and signals generated by the ECUs, which is often proprietary to the specific automobile manufacturer, so that the information regarding the ECU hardware and signals generated by the ECUs can be accessed in a standardized way by the mobile device and various mobile device applications. In this way, the large amount of data that exists in modern automobiles can be utilized more fully and can be accessed, for example, by mobile devices that have become widely used in recent years.

Another example embodiment includes the abstraction device including a connector, a mapping platform, and a transceiver. The connector is adapted to interface with an automotive CAN bus that communicates data signals in a first automobile-specific format with components of an automobile. The mapping platform is configured to convert a data signal from the first automobile-specific format into a mobile device format defined by an Application Programming Interface (API). Additionally, the transceiver is configured to wirelessly communicate the data signal in the mobile device format to a mobile device.

Another example embodiment includes a platform that includes a transceiver, an API, and a controller. The transceiver is configured to receive a wireless write signal originating at a specific automobile-agnostic mobile device application. The write signal is formatted in a mobile device format. The API is configured to convert the write signal from the mobile device format to an automobile-specific format appropriate for a particular make and model of automobile. Additionally, the controller is configured to communicate the write signal formatted in the automobile-specific format through a CAN bus of the automobile to alter a condition of an automotive component.

Another example embodiment includes method of communication between an automobile-agnostic mobile device and an automobile. The method includes authenticating that the automobile-agnostic mobile device possesses a read privilege. The method further includes receiving a data signal from a CAN bus in an automobile-specific format. The data signal is converted from the automobile-specific format to a general mobile device format defined by an API. The data signal formatted in the mobile device format is wirelessly transmitted to the specific automobile-agnostic mobile device.

Additionally, the communication between the mobile device and the CAN interface is preferably performed in a secure manner. The example embodiment includes access control so that various access levels are provided that restrict or enable reading or writing of particular values or to particular devices on the CAN bus. For example, one level of access might only allow reading information such as the current speed and restrict access to reading the GPS coordinates without further user authentication. Another level of access might allow reading the state of all devices on the CAN bus, but restrict writing to any of the safety systems, such as deploying the airbags.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates a block diagram of an example automotive data abstraction and communication system in which embodiments described herein may be implemented;

FIG. 1B illustrates communication of a write signal in the automotive data abstraction and communication system of FIG. 1A;

FIG. 1C illustrates communication of raw automotive data between a certified mobile device and an automobile in the automotive data abstraction and communication system of FIG. 1A;

FIG. 2 illustrates an example mapping platform 112 that may be included in the automotive data abstraction and communication system of FIGS. 1A-1C;

FIG. 3 illustrates a set of events that can be exposed to a mobile device according to some embodiments;

FIG. 4 is a flowchart of an example method of communication between an automobile-agnostic mobile device and an automobile that can be implemented in the automotive data abstraction and communication system of FIGS. 1A-1C; and

FIG. 5 is a block diagram illustrating an example computing device that is arranged for performing communication between a mobile device and a CAN bus that may be implemented in the automotive data abstraction and communication system of FIGS. 1A-1C.

### DETAILED DESCRIPTION OF SOME EXAMPLE EMBODIMENTS

Embodiments of the invention relate to the communication of signals between mobile devices and Controller Area Network (CAN) buses. Embodiments disclosed herein generally enable the communication of signals between electronic control units (ECUs) of an automobile and a mobile device. Data signals communicated from the ECUs to the mobile device may include information about the state of one or more of components of the automobile. In particular, in some embodiments the data signals, which are communicated from the ECUs to the CAN bus, are abstracted by an automotive data abstraction and communication device (abstraction device). The abstraction device connects directly to an On Board Diagnostics (OBD) connector that enables access to the CAN bus. The abstraction device converts the data signals from an automobile-specific format to a mobile device format defined by an Application Programming Interface (API). The abstraction device then wirelessly and securely transmits the data signals to the mobile device. By converting the data signals to the mobile device format, the mobile device may use the data signals without knowing the automobile-specific format. Additionally, the mobile device format defined by the API exposes the data signals, ECUs and other automobile hardware and software in a standardized way, thereby enabling multiple vendors or software developers to create mobile device applications that process the data signals.

Additionally, a user of the mobile device can send a write signal from the mobile device through the abstraction device to the CAN bus. The write signal enables the user of the mobile device to alter the state of one or more components included in the automobile. The write signal is formatted in the mobile device format defined by the API and wirelessly transmitted to the abstraction device. The abstraction device converts the write signal to the automobile-specific format and communicates the write signal to the automobile. By converting the write signal from the mobile device format defined by the API to the automobile-specific format, the abstraction device may interface with multiple automobiles. Additionally, the mobile device format defined by the API acts as a common programming language enabling multiple vendors to write mobile device applications that may communicate read and write signals to multiple types of automobile independent of model or manufacturer.

Additionally, the abstraction device includes a certification module, which controls access to some data signals and limits access to one or more components of the automobile through verification of a user, a mobile device application, a mobile device, software on the head unit or other device, or some combination thereof. By including the certification module, the system controls access to sensitive portions of the CAN bus, such as airbags, brakes, or GPS location. This assures that a virus, a rogue application, or misuse by a user cannot damage the automobile or injure the occupants, while allowing an approved application access to any required data or device. Additionally, the certification module allows the manufacturer to control dissemination of proprietary signals. Additional embodiments are described with reference to the appended drawings.

The certification module can be configured to grant various levels of access to the CAN bus and associated CAN messages based on a level of authorization associated with the application or device that requests such access. For example, a fully certified mobile device or a mobile device having a fully certified app (referred to herein as “OEM certified” can be assigned a full authentication level and granted access to native, raw data signals on the CAN bus. In this way, equipment used by manufacturers, authorized service technicians, etc., can be given direct access to raw CAN messages, without abstraction by an API. In this way, only OEM certified devices can obtain access to the raw CAN messages, thereby giving automobile manufacturers the ability to restrict access to raw CAN messages by devices that are not granted full certification. In contrast, in the absence of the embodiments described herein, there has been no certification in many automobiles regarding the devices that can be given direct access to raw CAN messages, which has presented significant security and safety issues.

Moreover, the certification module can be configured to grant more restrictive access to the CAN bus to mobile devices that do not qualify for OEM certification. For example, a mobile device that is authenticated by the certification module at a more restrictive authentication level, can be given access to higher-level events mapped from the CAN messages, as opposed to being given direct access to raw CAN messages. The authentication level might give only read access, or read access combined with write access for only certain events (i.e., those that do not pose a safety hazard).

As used herein and unless specified otherwise, the term “mobile device” extends to any device that can communicate with the abstraction devices described herein to obtain read or write access to messages or data signals communicated on a CAN bus. In many cases, the mobile device is a handheld, portable device, such as a smart phone or a tablet. However, the mobile device can be a computer, diagnostics equipment, a system operated by an automobile manufacturer or service technician, etc., and is not limited to portable devices.

As used herein, the term “CAN bus,” refers to any bus used in an automobile for communicating signals between ECUs or components. The CAN bus may be a bus that operates according to versions of the CAN specification, but is not limited thereto. The term “CAN bus” can therefore refer to buses that operate according to other specifications, including those that might be developed in the future.

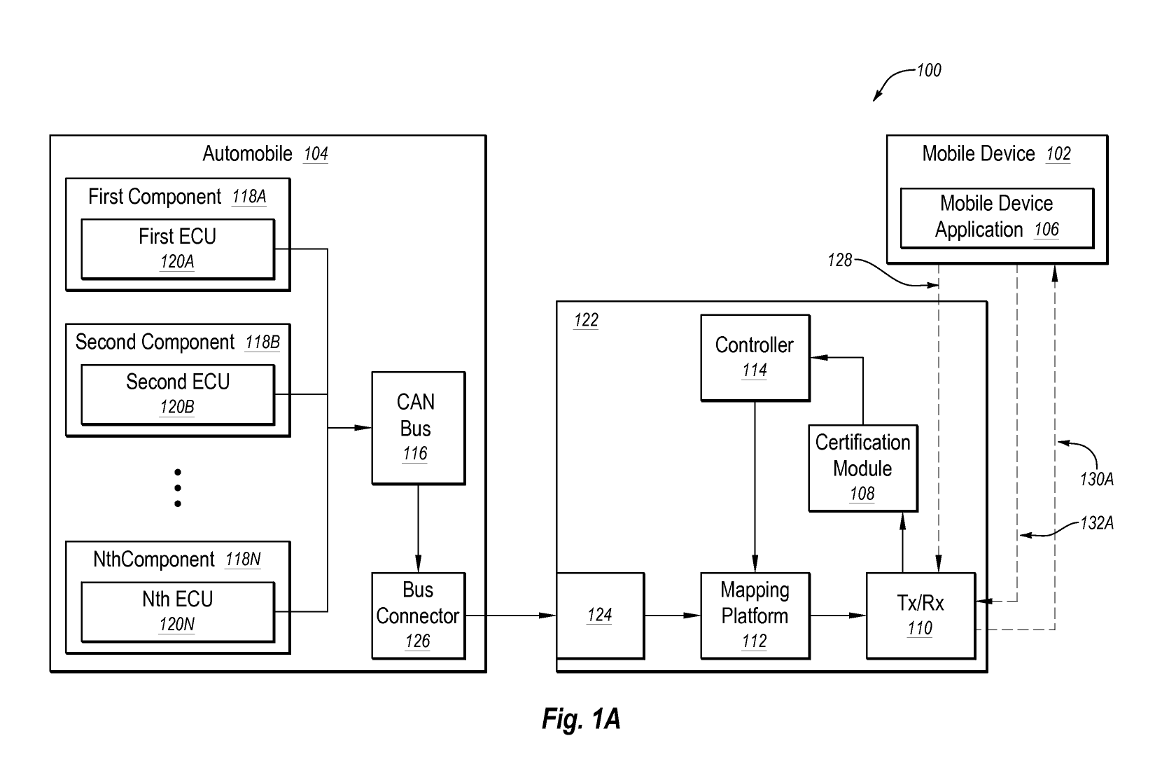

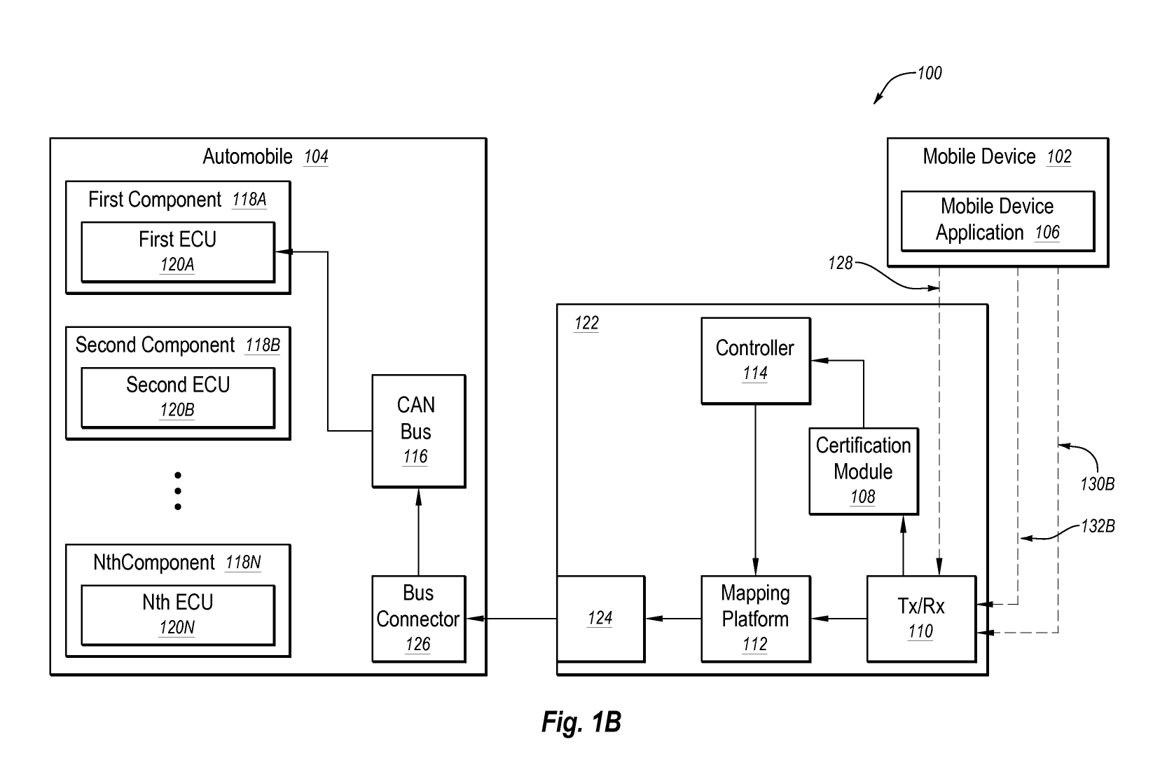

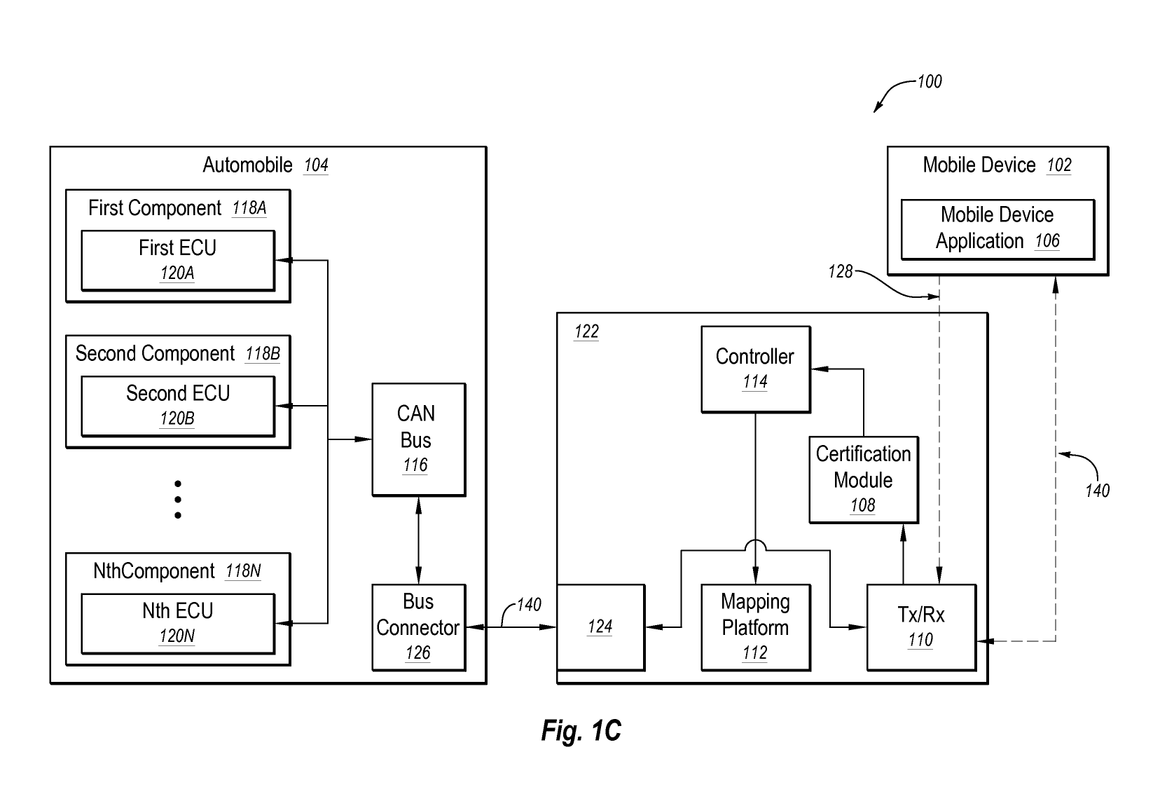

FIG. 1A illustrates a block diagram of an example automotive data abstraction and communication system (system) 100 in which embodiments described herein may be implemented. FIG. 1A depicts an example of an operating environment for the automotive data abstraction and communication systems described herein. FIG. 1A also illustrates an example in which a mobile device 102 is identified as having an authentication level that permits the mobile device 102 to have access to higher-level events mapped from CAN messages, as opposed to being given direct access to raw CAN messages.

In FIG. 1A, the system 100 includes an automobile 104, an abstraction device 122, and a mobile device 102. Generally, FIG. 1A depicts the communication of data signals from the automobile 104 to the abstraction device 122 and to the mobile device 102. The data signals are produced at the automobile 104, the format of the data signals are converted at the abstraction device 122, and the data signals are processed at the mobile device 102.

FIG. 1A depicts a system 100 that includes the automobile 104. The systems described herein can be used with substantially any mechanized system that uses a CAN bus as defined herein, including, but not limited to, industrial equipment, boats, or trucks, and the term “automobile” extends to any such vehicles. The systems described herein can also be adapted for use with other devices that have accessible data, such as medical equipment.

The automobile 104 may include multiple automotive components 118A-118N (generally, a component 118 or components 118). The components 118 include the individual apparatuses, systems, subsystems, mechanisms, etc. that are included in the automobile 104. The components 118 may include, but are not limited to, windows, door locks, oxygen sensors, an ignition system, windshield wipers, brakes, engines, GPS and navigation systems, a tachometer, etc.

The automobile 104 may additionally include one or more electronic control units 120A-120N (an ECU 120 or ECUs 120). The ECUs 120 are associated with the components 118. As used with respect to the relationship between the ECUs 120 and the components 118, the term “associated with” may refer to the component 118 including an ECU 120, the component 118 being coupled to and ECU 120 for monitoring a state of the component 118, the ECU 120 controlling the component 118, or some combination thereof. As illustrated in FIG. 1A, one ECU 120 is associated with one component 118. However, this depiction is not meant to be limiting. In some embodiments, one ECU 120 may be associated with multiple components 118. Additionally or alternatively, multiple ECUs 120 may be associated with a single component 118. Additionally or alternatively, some embodiments include ECUs 120 associated with some subset of ECUs 120, etc.

In FIG. 1A, a first component 118A is associated with a first ECU 120A, a second component 118B is associated with a second ECU 120B, and an Nth component 118N is associated with an Nth ECU 120N. The inclusion of the Nth component 118N, the Nth ECU 120N, and the ellipses is meant to indicate that the number of components 118 and/or ECUs 120 are not limited. That is, the automobile 104 may include hundreds or thousands of components 118 and/or ECUs 120, for instance.

The first ECU 120A associated with the first component 118 may monitor the first component 118. The ECU 120A may communicate a state or a condition of the first component as a data signal to the CAN bus 116. For example, if the first component 118A was the steering wheel, the first ECU 120A may communicate the radial position of the steering wheel in real time to the CAN bus 116. Similarly, the second ECU 120B and the Nth ECU 120N may communicate the data signals to the CAN bus 116 regarding the state or the condition of the second component 118B and the Nth component 120N, respectively. Accordingly, the data signals may include, but are not limited to, positions of the windows, positions of the door locks, oxygen levels measured in the oxygen sensors, ignition timing, state of the windshield wipers, a position of the steering wheel, or RPM of the engine.

The data signals may be formatted in an automobile-specific format—i.e., specific to an automobile make and model. The automobile-specific format generally refers to the format of the data signals for the automobile 104. That is, the automobile 104 may be manufactured by a first manufacturer that may have an automobile-specific format for all its automobiles. Alternatively, the first manufacturer may have an automobile-specific format for different models, years, option packages, etc. Generally, the automobile-specific formats of different automobiles 104 are not the same. Thus, an automobile manufactured by the first manufacturer has a different automobile-specific format that a second automobile manufactured by a second manufacture. Additionally or alternatively, in some embodiments, the data signals may be differential signals.

The CAN bus 116 receives the data signals from the ECUs 120. Additionally, the CAN bus 116 may enable the components 118 or some subset thereof to internally communicate without an additional computer system. Thus, data signals received at the CAN bus 116 may be available for download, may be internally communicated within the automobile 104, or may be dropped.

In some embodiments, the CAN bus 116 may be coupled to a bus connector 126 that enables access to the CAN bus 116. For example, in this and other embodiments, the automobile 104 may include an On Board Diagnostics (OBD) connector. The bus connector may be configured according to an OBD II specification, for instance. In embodiments with multiple CAN buses 116, the automobile 104 may include multiple bus connectors 126 and/or alternative bus connectors that enable access to one or more CAN buses 116. In most modern automobiles, the CAN bus 116 includes the bus connector 126 located under the hood or accessible through the removal of a panel in the cabin of the automobile 104. However, embodiments described herein can be implemented by using connector 124 that connects with CAN bus 116 in any available way.

The data signals or some subset thereof may be communicated to the abstraction device 122. In some embodiments, the abstraction device 122 is a discrete unit that can be adapted for use with one or more existing or new automobiles 104. For example, as explained herein, the abstraction device 122 can be embodied in a discrete unit that can be installed in an existing or new automobile 104 by connecting it to the bus connector 126 (e.g., an OBD II connector) associated with CAN bus 116. In this way, the methods and systems described herein can be easily used with substantially any new or existing automobile 104 that includes a CAN bus 116.

In other embodiments, the abstraction device 122 or elements thereof may be integrated into new automobiles or retrofitted into an existing automobile. Under this approach, the elements of the abstraction device 122 are a substantially permanent system of automobile 104. In this case, abstraction device 122 can replace or supplement the bus connector 126 that may otherwise be present in the automobile 104. In these embodiments, the abstraction device 122 may be a platform within a larger apparatus or system or may be an integrated circuit with controllers and/or microcontrollers that manage or dictate the function of the abstraction device 122.

The abstraction device 122 couples with the bus connector 126 associated with the CAN bus 116 via a connector 124. For example, the CAN bus 116 may have a bus connector 126 (e.g., an OBD II connector) that is adapted to connect with the connector 124 or the abstraction device 122 may include the connector adapted to interface with the bus connector 126. Generally, the interface between the connector 124 and the bus connector 126 includes a physical connection as well an electrical interface such that the data signals communicated to the CAN bus 116 may be further communicated to the abstraction device 122.

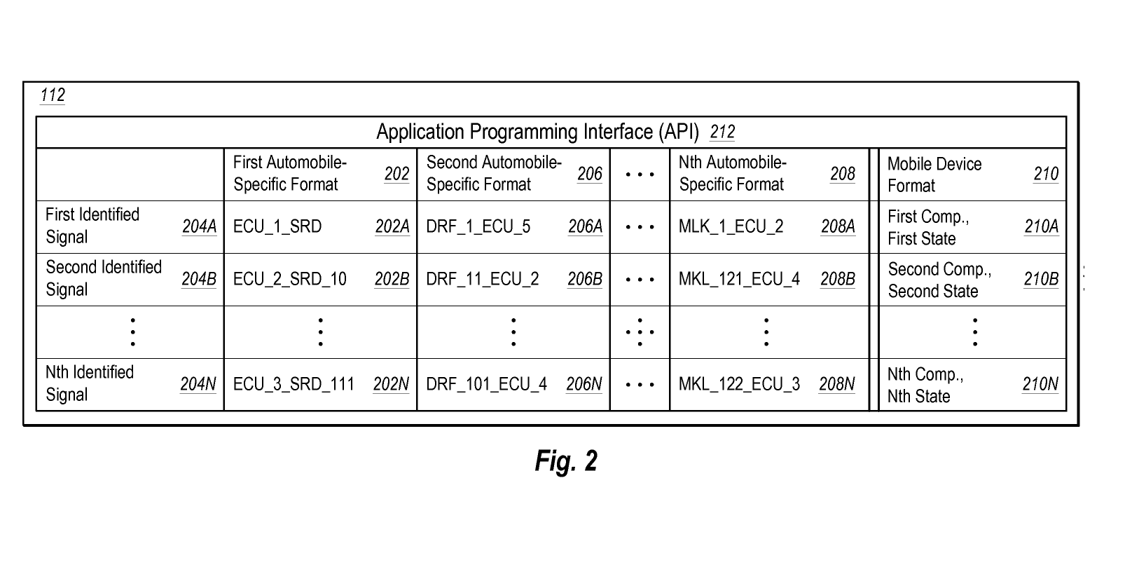

When connected to the CAN bus 116, the connector 124 may communicate the data signals to mapping platform 112. Generally, the mapping platform 112 may be configured to convert a data signal from the automobile-specific format into a mobile device format defined by an Application Programming Interface (API). Additionally, in some embodiments, the API included in the mapping platform 112 may enable the conversion of data signals from multiple automobile-specific formats to the mobile device format. Thus, the mapping platform 112 may not be specific to the automobile 104. Some additional details of the mapping platform 112 and the API are discussed with reference to FIG. 2.

Alternatively, in some embodiments, the abstraction device 122 may include one or more controllers 114 that may be configured to receive one or more data signals from the CAN bus 116. The controller 114 may then communicate the data signals to the mapping platform 112.

In the embodiment of FIGS. 1A-1C, the abstraction device 122 includes a certification module 108 configured to limit access to the data signal converted to the mobile device format by the mapping platform 112. In the example of FIG. 1A, the certification module 108 determines that mobile device 102 is authenticated at a level that permits the mobile device 102 to access events mapped from the CAN messages by the mapping platform 112 rather than accessing the native, raw CAN messages. For instance, mobile device 102 can be a device operated by a driver or passenger, with a mobile device application 106 that is configured to detect, respond to, or initiate events mapped from the CAN messages by the mapping platform 112. The events can be limited to those that have been determined to be appropriate for the authentication level of the mobile device 102. In this way, mobile device 102, in this example, is prevented from having full access to the raw CAN messages, thereby substantially limiting the ability of mobile device 102 to perform action that might damage the automobile 104 or put the passengers in danger.

In this and other embodiments, the certification module 108 may function through communication with a transceiver 110 and a controller 114. The transceiver 110 (“Tx/Rx” in FIGS. 1A-1C) may receive an identification signal from the mobile device 102 and/or a mobile device application 106 on the mobile device 102. The communication of the identification signal is indicated by the arrow 128 in FIGS. 1A-1C. The identification signal 128 may include one or more privileges possessed by the mobile device 102 and/or the mobile device application 106. For example, the mobile device 102 may be owned or operated by a mechanic who may have a specific privilege without authentication of the specific mobile device application 106 or the specific mobile device application 106 may include a privilege. Some examples of privileges may include one or more read privileges and/or one or more write privileges. The identification signal 128 may be communicated from the transceiver 110 to the certification module 108. The certification module 108 may verify or authenticate whether the mobile device 102 and/or the mobile device application 106 includes a specific privilege.

The certification module 108 may communicate whether the mobile device 102 and/or the mobile device application 106 has an authentication level that permits access to events mapped by mapping module 112 or direct access to raw CAN messages. In this example, in which mobile device 102 has an authentication level that permits access to events, the certification module communicates whether the authentication level grants the mobile device 102 specific privilege to the controller 114. If the mobile device 102 and/or the mobile device application 106 do not include the specific privilege, then the controller 114 may prohibit conversion of data signals and/or transmission of the data signals from the transceiver 110 to the mobile device 102. If however, the mobile device 102 and/or the mobile device application 106 do include the specific privilege, then the controller 114 may allow the mapping platform 112 to perform a conversion and/or the transmission of the data signals to the mobile device 102 by the transceiver 110. The certification module 108 may therefore restrict the transmission of the data signal through authentication of privileges assigned to the mobile device 102 or the mobile device application 106.

In some embodiments, the certification module 108 may be able to authenticate or verify multiple read privileges. Different read privileges may correspond to different subsets of the data signals that may be converted by the mapping platform 112 and/or transmitted to the mobile device 102. For example, the read privileges may include a first read privilege that prevents the transmission of a first subset of data signals and a second read privilege that may allow the transmission of the first subset of data signals.

Abstraction device 122 can be implemented using systems that enhance the security of the execution environment, thereby improving security and reducing the possibility that the abstraction device 122 and the related services could be compromised by viruses or malware. For example, abstraction device 122 can be implemented using a Trusted Execution Environment, which can ensure that sensitive data is stored, processed, and communicated in a secure way.

As stated above, the transceiver 110 may receive data signals that have been converted to the mobile device format defined by the API. The transceiver 110 may then communicate the data signal formatted in the mobile device format to the mobile device 102. In FIG. 1A, the communication of the data signal to the mobile device 102 is represented by arrow 130A. More specifically, in this and other embodiments, the transceiver 110 may be configured to wirelessly communicate the data signal in the mobile device format to the mobile device 102. The transceiver 110 may include several configurations. In this and other embodiments, the transceiver 110 may include: a wireless receiver to receive identification signals and/or write signals from the mobile device 102; another receiver to receive the data signals from the mapping platform 112; a wireless transmitter to communicate the data signals in the API to the mobile device 102; and another transmitter that communicates identification signals to the communication module 108 and/or write signals to the mapping platform 112. Some details of the write signals are discussed with reference to FIG. 1B. In some embodiments, the transceiver 110 includes a Bluetooth transceiver.

Additionally in some embodiments, the transceiver 110 may establish a secure channel between the abstraction device 122 and the mobile device 102. In addition to or alternative to the secure channel, the abstraction device 122 may encrypt the data signals formatted in the mobile device format. The mobile device 102 may decrypt the data signals. The inclusion of the secure channel and/or encryption may enhance security of the data signals communicated to the mobile device 102.

The mobile device 102 may include but is not limited to, a mobile phone, a smartphone, a personal digital assistant, a laptop computer, a tablet computer, or other mobile communication device. Accordingly, the mobile device format may include or be configured to operate with any programming format or language including, but not limited to, JavaScript, C++, iOS, Android, etc.

The mobile device 102 receives the data signals communicated from the abstraction device 122. In embodiments in which the transceiver 110 wirelessly communicates the data signals to the mobile device 102, the mobile device 102 includes wireless capabilities such as Bluetooth, Wi-Fi, 3G, 4G, LTE, etc. For example, if the transceiver 110 includes a Bluetooth transceiver, the mobile device 102 includes Bluetooth capabilities. Generally, the mobile device 102 includes one or more mobile device applications 106 that process the data signals. The mobile device application 106 may be loaded or installed on the mobile device 102. Alternatively, the mobile device 102 may access the mobile device application 106 via a cloud or internet browser, for example. The mobile device application 106 may be written or created to process data signals in the mobile device format rather than the automobile-specific format. Accordingly, the mobile device application 106 may be automobile-agnostic. That is, the mobile device application 106 may process data signals from any automobile 104 once the data signals formatted in the automobile-specific format are converted by the mapping platform 112.

In some embodiments, the mobile device application 106 includes an ability to perform an API call. The API call is represented in FIG. 1A by arrow 132A. The API call 132A may be an integrated portion of the mobile device application 106 and may allow a user of the mobile device 102 to request data signals from the automobile 104. The API call 132A may be communicated to the transceiver 110 which then relays the content of the API call 132A through the mapping platform 112 which converts the requested data signals to the mobile device format. The requested data signals are transmitted to the mobile device 102.

By processing the data signals, the mobile device application 106 may function better than mobile device application without the data signals or may be able to provide functionality not possible without the data signals. For example, the mobile device applications 106 may include a navigation application. The navigation application may receive GPS signals as well as data signals related to a radial position of the steering wheel, an angle of the tires, a speed, etc. of the automobile 104. The navigation application may process the GPS signals as well as the data signals from the automobile 104. Thus, the navigation application may output more accurate navigation data than another navigation application that only processes GPS signals.

Additionally or alternatively, the mobile device application 106 may enable abstraction of data signals for aggregate uses. For some aggregate uses, the mobile device application 106 may sync with one or more secondary systems (not shown). For example, the mobile device 102 may abstract data signals related to states of the windshield wipers. The mobile device 102 may communicate with a secondary system that determines weather patterns based on the state of windshield wipers in multiple automobiles in a given location at a given time.

Examples mobile device applications 106 are not limited to the above examples. The mobile device application 106 may include any application that processes, abstracts, or evaluates data signals from the automobile 104 or transmits write signals to the automobile 104.

FIG. 1B illustrates communication of a write signal in the system 100 of FIG. 1A. Generally, the mobile device 102 may communicate the write signal to the abstraction device 122 and the abstraction device 122 may communicate the write signal to the automobile 104.

The write signal may include a command or setting that alters a condition of one or more of the components 118. The write signal may originate at the mobile device application 106 and be communicated by the mobile device 102 to the transceiver 110. The communication of the write signal to the transceiver 110 is represented in FIG. 1B by arrow 130B. For example, the mobile device application 106 may include a capability to roll up the windows in the automobile 104. Accordingly, mobile device application 106 may include the capability to originate the write signal including a “roll up the windows” command. The “roll up the windows” command may be communicated to the transceiver 110 of the abstraction device 122. The write signals may be formatted in the mobile device format. Thus, the mobile device application 106 in which the write signal originates may be an automobile-agnostic mobile device application.

Alternatively, like in FIG. 1A, the mobile device application 106 may include a write API call which is communicated to the transceiver 110. The write API call is represented in FIG. 1B by arrow 132B. In this and other embodiments, the write signal may be preceded by the write API call that communicates a request for an automobile-specific format in which the write signal may be communicated to the abstraction device 122.

In some embodiments, a secure channel may be established between the mobile device 102 and the transceiver 110. In addition to or alternative to the secure channel, the mobile device 102 may encrypt the write signal formatted in the mobile device format. The abstraction device 122 or the transceiver 110 may decrypt the write signal. The inclusion of the secure channel and/or encryption enhances security of the write signals communicated to the abstraction device 122.

In addition to the write signal, the mobile device 102 may communicate the identifying signal to the transceiver 110. As in FIG. 1A, arrow 128 represents the communication of the identifying signal to the transceiver 110. As discussed above, the identifying signal 128 may include one or more privileges possessed by the mobile device 102 and/or the mobile device application 106.

The transceiver 110 included in the abstraction device 122 may be configured to receive the write signal and the identification signal from the mobile device 102. The identification signal may be communicated to the certification module 108. The certification module 108 verifies that the mobile device application 106 and/or the mobile device 102 possess a write privilege. In some embodiments, multiple write privileges exist. Multiple write privileges may prevent a user of the mobile device 102 from accessing specific components 118. For example, a first write privilege may enable write signals related to windows, door locks, and the like, but prevent write signals related to air bag deployment, engine timing, etc. A second write privilege may enable write signals related to air bag deployment and engine timing. The first write privilege may be suited for users while the second write privilege may be suited for the manufacturer or maintenance personnel.

Many existing automobiles 104 have proprietary data and hardware systems associated with ECUs 120. In some cases, there is the possibility, in the absence of the embodiments described herein, of the existence of security holes that may cause problems regarding access to the components 120 or safety issues regarding operation of the automobile 104. For example, an ECU 120 may be associated with the brakes of automobile 104 and might be capable of responding to a write signal to lock the brakes. If the ECU 120 receives the signal to lock the brakes at an unexpected time (either maliciously or inadvertently) during driving, the automobile could experience unsafe operating conditions.

Because of the authentication and security features associated with certification module 108, the abstraction device 122 significantly reduces the likelihood that a malicious our inadvertent commands are sent to various ECU 120 of automobile 104, particularly while driving. When automotive data abstraction device 122 is implemented in a way in which it is integrated into automobile 104 or otherwise limits other access to CAN bus 116, the abstraction device 122 can significantly limit access to any potential security holes or operation safety issues that might otherwise exist.

The certification module 106 may communicate to the controller 114 whether the mobile device application 106 and/or the mobile device 102 possess write privilege. If the mobile device application 106 and/or the mobile device 102 do not possess write privilege, the controller 114 may communicate a control to the mapping platform 112 that prevents the mapping platform 112 from converting the write signal from the mobile device format to one of the automobile-specific formats appropriate for the automobile 104. If however, the mobile device application 106 and/or the mobile device 102 do possess the write privilege, the controller 114 allows the mapping platform 112 to convert the write signal from the mobile device format to one of the automobile-specific formats appropriate for the automobile 104.

Additionally, the mapping platform 112 may then communicate the write signal formatted in the one of the automobile-specific formats through the bus connector 126 to the CAN bus 116 of the automobile 104. The CAN bus 116 may communicate the write signal to one or more ECUs 120 to alter a condition of one or more of the components 118. For example, as illustrated in FIG. 1B, the write signal may be communicated to the first ECU 120A. The first ECU 120A may then communicate the write signal to the first component 118A to affect a condition of the first component 118A.

Alternatively, one or more controllers 114 included in the abstraction device 122 may be configured to communicate the write signal formatted in the one of the automobile-specific formats through the bus connector 126 to the CAN bus 116 of the automobile 104.

By using write privileges, the certification module 108 may enable a manufacturer of the automobile 104 to write a custom first party mobile device application. The first party mobile device application may be exclusively accessible to the manufacturer or may include functionalities seen only by the manufacture. This may protect proprietary components 118 or proprietary aspects of the automobile-specific format.

FIG. 1C illustrates communication of raw automotive data between a certified mobile device and an automobile 104 in the automotive data abstraction and communication system of FIG. 1A. Specifically, FIG. 1C illustrates an example in which the certification module 108 grants the mobile device 102 full access to native, raw CAN messages based on the mobile device 102 being assigned a full authentication level. In this way, OEM certified equipment used by manufacturers, authorized service technicians, etc., is given direct access to raw CAN messages, without abstraction by the API. Thus, in some embodiments, only OEM certified devices can obtain access to the raw CAN messages, thereby giving automobile manufacturers the ability to restrict access to raw CAN messages by devices that are not granted full certification. In contrast, FIGS. 1A and 1B illustrate an example in which mobile device 102, without the full authentication level associated with OEM certification, gains access to higher-level events mapped from the CAN messages by the mapping platform 112.

As shown in FIG. 1C, mobile device 102, which is OEM certified or operates a mobile device application 106 that is OEM certified, is determined by certification 108 to have a full authentication level. Based on the full authentication level, the abstraction device 122 permits the mobile device 102 to communicate directly with automobile 104 using raw CAN messages 140, effectively bypassing the functionality of mapping platform 112.

FIG. 2 illustrates an example mapping platform 112 that may be included in the system 100 of FIGS. 1A-1C. The mapping platform 112 includes an API 212 including multiple identified signals 204A-204N (generally, an identified signal 204 or identified signals 204) formatted in a mobile device format 210 defined by the API 212 and formatted in multiple automobile-specific formats 202, 206, and 208 (generally, automobile-specific formats 202/206/208).

The mapping platform 112 may be generated through cooperation with an automobile manufacturer or through discovery of various signals include in an automobile-specific format 202/206/208. For example, a first manufacture may simply provide the contents, formats, variables, etc. of the first automobile-specific format 202. Alternatively, an API developer may connect to a CAN bus and operate an automobile to extract the contents, formats, variables, etc.

The API 212 may convert a write signal from the mobile device format 210 to one of the automobile-specific formats 202/206/208 appropriate for an automobile. Additionally, the API 212 may convert a data signal from one or more of the automobile-specific formats 202/206/208 to the mobile device format 210.

The identified signals 204 may include any state of any of the components included in the automobile. With combined reference to FIGS. 1A and 2, a first identified signal 204A may include whether the first component 118A is operating, a measurement of the first component 118A, or a reading related to the first component 118A, for instance. For example, if the first component 118A is the windshield wipers, then the first identified signal 204A may include whether the windshield wipers are operating. In FIG. 2, the API 212 includes a first identified signal 204A, a second identified signal 204B, and an Nth identified signal 204N. The inclusion of the Nth identified signal 204N and the ellipses represents that the number of identified signals 204 is without limitation.

Referring specifically to FIG. 2, for each of the automobile-specific formats 202/206/208, the first identified signal 204A may include a signal with different content or a different format. That is, for a first automobile-specific format 202 the first identified signal 204A includes the signal “ECU_{—}1_SRD” 202A. For a second automobile-specific format 206, the first identified signal 204A includes the signal “DRF_{—}1_ECU_{—}5” 206A. For an Nth automobile-specific format 208, the first identified signal 204A includes the signal “MLK_{—}1_ECU_{—}2” 208A. Each of the signals “ECU_{—}1_SRD” 202A, “DRF_{—}1_ECU_{—}5” 206A, or “MLK_{—}1_ECU_{—}2” 208A, indicate that a first component is in a first state. Thus, when the mapping platform 112 receives a data signal including any of the signals “ECU_{—}1_SRD” 202A, “DRF_{—}1_ECU_{—}5” 206A, or “MLK_{—}1_ECU_{—}2” 208A, the API 212 converts them to a corresponding signal in the API 210, specifically “First Comp., First State” 210A.

Additionally, when the API 212 receives a write signal including “First Comp., First State” 210A, the API 212 determines which automobile-specific format 202/206/208 is appropriate and converts the signal “First Comp., First State” 210A, to one of the appropriate automobile-specific format 202/206/208. For example, if the mapping platform 112 is communicating with a first automobile that communicates data signals in the first automobile-specific format 202, then the API 212 may determine that the mapping platform 112 is communicating with the first automobile and accordingly that the first automobile-specific format 202 is appropriate. When the mapping platform 112 receives a write signal including “First Comp., First State” 210A, the API 212 converts the write signal to “ECU_{—}1_SRD” 202A.

With combined reference to FIGS. 1A and 2, multiple components and/or systems may be utilized to determine which automobile-specific format 202/206/208 is appropriate for the automobile 104. As described above, the mapping platform 112 may determine which of the automobile-specific formats 202/206/208 is appropriate for the automobile 104, but this is not meant to be limiting. The controller 114, another controller (not shown), the certification module 108, etc. may alternatively or in some combination, determine which of the automobile-specific formats 202/206/208 is appropriate for the automobile 104.

In FIG. 2, the API 212 includes the first automobile-specific format 202, the second automobile-specific format 206, and the Nth automobile-specific format 208. The inclusion of the Nth automobile-specific format 208 and the ellipses represents that the number of automobile-specific formats 202/206/208 is without limitation. Because the API 212 includes the automobile-specific formats 202/206/208, the API 212 may enable the conversion of write signals from the mobile device format 210 into multiple automobile-specific formats 202/206/208 as well as the conversion of data signals from multiple automobile-specific formats 202/206/208 into the mobile device format 210.

In some embodiments, the automobile-specific formats 202/206/208 included in the API 212 are updatable. For example, if in the second automobile-specific format 206, the Nth identified signal 204N is modified, then the API 212 may be updated to incorporate the modification. Additionally, supplementary automobile-specific formats 202/206/208 may be incorporated into the API 212. Additionally still, the mobile device format 210 may be periodically updated as technology in automobiles changes and/or new components are added, for instance.

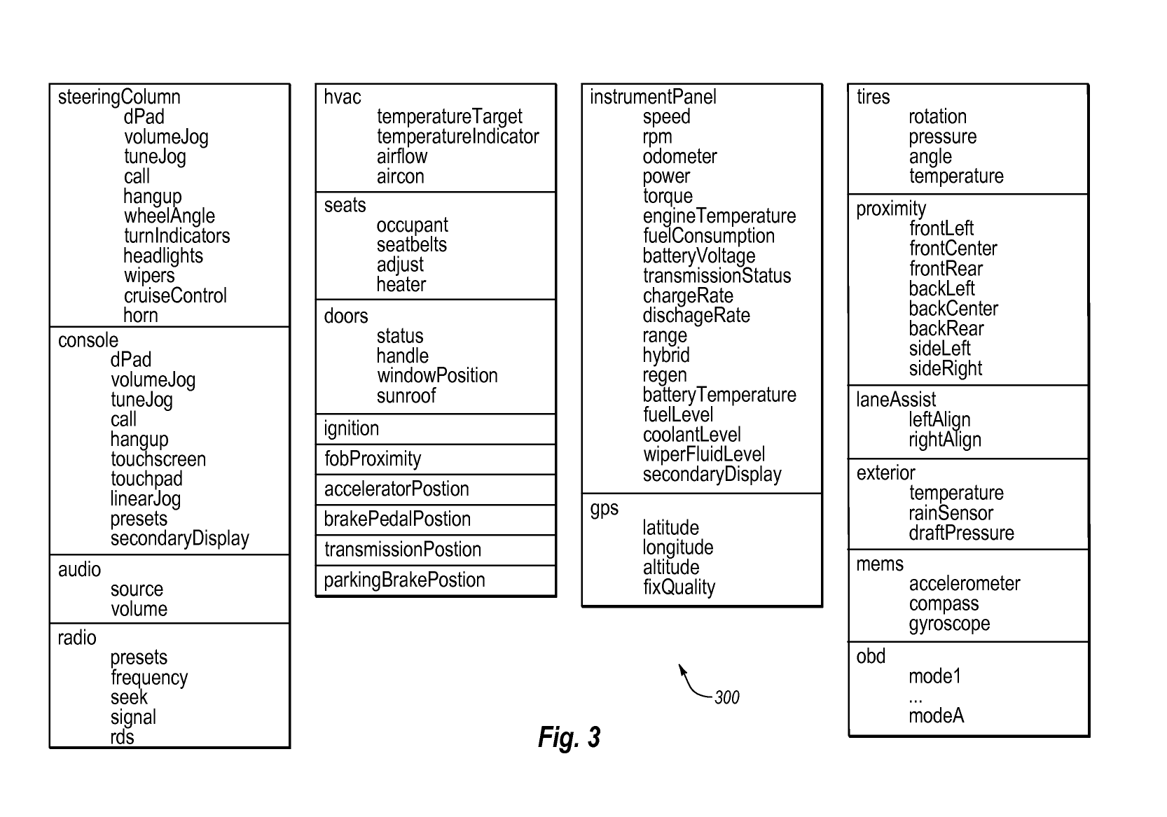

FIG. 3 presents a set of events 300 that can be exposed to mobile devices that are determined to have an authentication level that grants access to higher-level events converted by the mapping platform, as opposed to having direct access to raw CAN messages. The set of events 300 depicted in FIG. 3 is just one example of the events that can be exposed to mobile devices. In this example, the set of events 300 are read-only or are selected to have little or no risk of potential damage to the automobile or danger to occupants if the events 300 happen to be accessed by viruses or malware or are initiated by user error.

In some embodiments, only a subset of events 300 are exposed to certain mobile devices if, for example, a certain mobile device is determined to have a more restricted authentication level. In general, the set of events 300 are selected based on the authentication level of the mobile device, the ECUs present in a particular automobile make and model, and the intended purpose and functionality of the mobile devices that are to be used with the abstraction devices described herein.

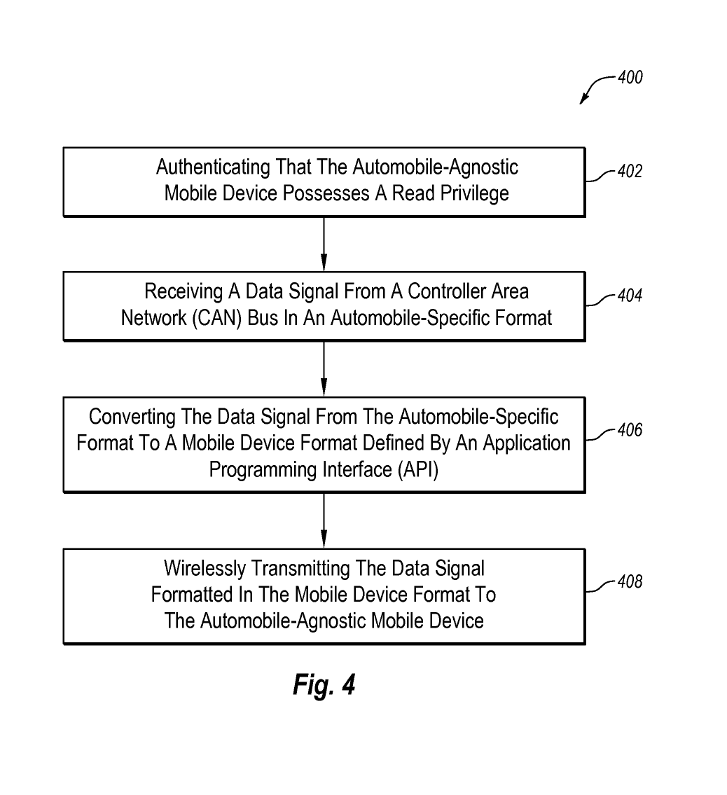

FIG. 4 is a flowchart of an example method 400 of communication between an automobile-agnostic mobile device and an automobile that can be implemented in the system 100 of FIGS. 1A-1C and may be performed by the abstraction device 122 of FIGS. 1A-1C in some embodiments. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

The method 400 may begin at 402 by authenticating that the automobile-agnostic mobile device possesses a read privilege. In this example, it is determined that the mobile device has an authentication level that permits the mobile device to access events that are mapped by the mapping platform from CAN messages. In other examples, the authentication level can permit a mobile device to access raw CAN messages. According to the example of FIG. 4, the read privilege may be included in an identifying signal that is transmitted by the mobile device. The identifying signal may be included in one or more other signals or may be a coded message that identifies the mobile device. The identifying signal or the read privilege may be based on a user operating the mobile device, the mobile device, or the mobile device application, for example. The authenticating may additionally include a verification of the mobile device and/or a mobile device application through a certification module, for instance. In some embodiments, there may be multiple read privileges for different users, different mobile devices, different mobile device applications, or some combination thereof.

At 404, the method 400 may include receiving a data signal from a CAN bus in an automobile-specific format. The automobile-specific format may specific to the automobile, a manufacture, for a set of automobiles, etc. The data signals may be received through directly an interface between a connector and a bus connector that enables access with the CAN bus.

At 406, the method 400 may include converting the data signal from the automobile-specific format to a mobile device format defined by an API. In some embodiments, the API may be used to convert the automobile-specific format to a mobile device format defined by the API. The API may include multiple automobile-specific formats, any of which may be converted to the mobile device format using the API. Thus, the API may be automobile-agnostic.

At 408, the method 400 may include wirelessly transmitting the data signal formatted in the mobile device format to the automobile-agnostic mobile device. The wireless transmission may utilize a secure channel and/or an encryption technique that may add layers of security. In some examples, the wireless transmission may make use of Bluetooth technology.

Additionally, in some embodiments, a write signal formatted in the mobile device format may be received from the mobile device. The write signal may be wirelessly transmitted from the mobile device and may originate at an automobile-agnostic mobile device application. In some embodiments, the write signal may be wirelessly transmitted utilizing a secure channel and/or encryption technique.

Additionally, in some embodiments, whether the mobile device possesses a write privilege may be authenticated. The authentication may be performed based on the identifying signal. In some embodiments, there may be multiple write privileges for different users, different mobile devices, different mobile device applications, or some combination thereof. The write signal may be converted from the mobile device format to the automobile-specific format. Conversion of the write signal may occur at the mapping platform in some embodiments. The write signal in the automobile-specific format may then be communicated to the automobile through a direct connection between the connector and the bus connector that enables access to the CAN bus. The write signal may be communicated to one or more ECUs to affect a condition of an automotive component.

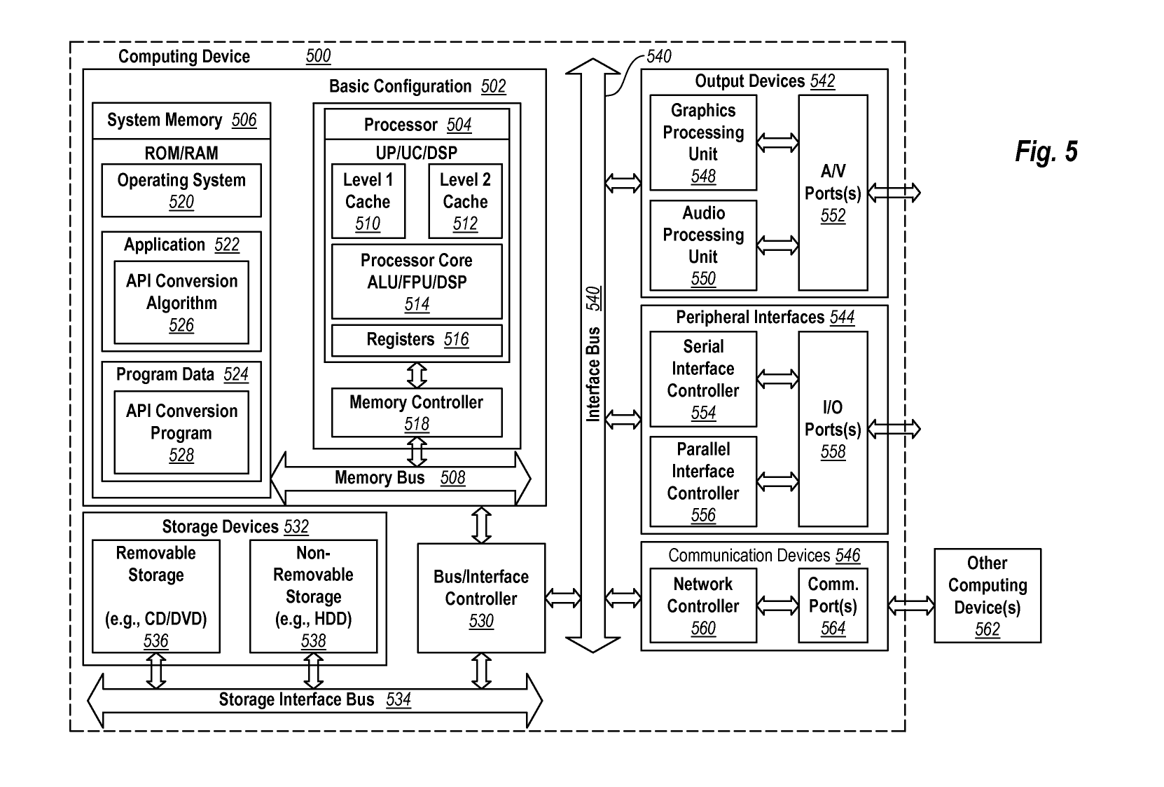

FIG. 5 is a block diagram illustrating an example computing device 500 that is arranged for performing communication between a mobile device and a CAN bus in accordance with the present disclosure. In a basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations, memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524. Application 522 may include API conversion algorithms 526 that are arranged to convert signals in automobile-specific formats to mobile device format and/or convert signals formatted in the mobile device format to an automobile-specific format. Program data 524 may include the API conversion programs 528 that may be useful for communication between the mobile device and the CAN bus as is described herein. In some embodiments, application 522 may be arranged to operate with program data 524 on operating system 520 such that communicating enterprise media content may be performed on the computing device 500. This described basic configuration 502 is illustrated in FIG. 5 by those components within the inner box 502 on the left side of FIG. 5.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536, and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

The present invention may be embodied in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An abstraction and communication device comprising:
a connector adapted to interface with an automotive Controller Area Network (CAN) bus that communicates data signals in a first automobile-specific format with components of an automobile;
a mapping platform configured to convert a data signal from the first automobile-specific format into a mobile device format defined by an Application Programming Interface (API);
a transceiver configured to wirelessly communicate the data signal in the mobile device format to a mobile device.

2. The abstraction and communication device of claim 1, further comprising a certification module configured to limit access to the data signal converted to the mobile device format.

3. The abstraction and communication device of claim 1, wherein the certification module is configured to:
grant a first mobile device with a first authentication level access to events in the mobile device format after conversion by the mapping module; and
grant a second mobile device with a second authentication level access to raw data without conversion by the mapping module.

4. The abstraction and communication device of claim 1, wherein the API enables the conversion of data signals in a plurality of automobile-specific formats to the mobile device format.

5. The abstraction and communication device of claim 4, wherein the API further enables the conversion of write signals in the mobile device format to the plurality of automobile-specific formats.

6. The abstraction and communication device of claim 4, wherein the plurality of automobile-specific formats is updatable.

7. The abstraction and communication device of claim 1, wherein the mapping platform is further configured to:
convert a write signal in the mobile device format communicated from the mobile device to the first automobile-specific format, and
communicate the write signal in the automobile-specific format through the automotive CAN bus to affect a condition of a component of the automobile.

8. The abstraction and communication device of claim 7, wherein the write signal communicated from the mobile device originates at an automobile-agnostic mobile device application.

9. The abstraction and communication device of claim 1, wherein the certification module restricts the transmission of the data signal through authentication of read privileges possessed by the mobile device.

10. The abstraction and communication device of claim 9, wherein the read privileges include a first read privilege that prevents the transmission of the data signal and a second read privilege that allows the transmission of the data signal.

11. The abstraction and communication device of claim 1, wherein the certification module further restricts communication of write signals through authentication of write privileges possessed by the mobile device.

12. The abstraction and communication device of claim 1, wherein the transceiver comprises a Bluetooth transceiver.

13. The abstraction and communication device of claim 1, wherein the connector is adapted to interface with an On Board Diagnostics (OBD) connector.

14. A platform comprising:
a transceiver configured to receive a wireless write signal originating at an automobile-agnostic mobile device application, wherein the write signal is formatted in a mobile device format;
an Application Programming Interface (API) configured to convert the write signal from the mobile device format to an automobile-specific format appropriate for an automobile; and
a controller configured to communicate the write signal formatted in the automobile-specific format through a Controller Area Network (CAN) bus of the automobile to alter a condition of an automotive component.

15. The platform of claim 14, further comprising a certification module configured to verify that the automobile-agnostic mobile device application possesses a write privilege.

16. The platform of claim 15, further comprising a connector adapted to interface with an On Board Diagnostics (OBD) connector that enables access to the CAN bus.

17. The platform of claim 15, wherein:
the certification module is further configured to verify that the automobile-agnostic mobile device application possesses a read privilege;
the controller is further configured to receive a data signal from the CAN bus formatted in the automobile-specific format;
the API is further configured to convert the data signal from the automobile-specific formats to the mobile device format; and
the transceiver is further configured to wirelessly transmit the data signal in the mobile device format to the automobile-agnostic mobile device application.

18. The platform of claim 15, wherein the certification module enables a manufacturer of the automobile to write a first party mobile device application exclusively accessible to the manufacturer.

19. A method of communication between an automobile-agnostic mobile device and an automobile, the method comprising:
authenticating that the automobile-agnostic mobile device possesses a read privilege;
receiving a data signal from a Control Access Network (CAN) bus in an automobile-specific format;
converting the data signal from the automobile-specific format to a mobile device format defined by an Application Programming Interface (API);
wirelessly transmitting the data signal formatted in the mobile device format to the automobile-agnostic mobile device, such that the automobile-agnostic mobile device can access the data signal in the mobile device format according to the read privilege.

20. The method of communication of claim 19, further comprising:
receiving from the automobile-agnostic mobile device, a write signal formatted in the mobile device format;
authenticating that the automobile-agnostic mobile device possesses a write privilege;
converting the write signal from the mobile device format to the automobile-specific format;
communicating the write signal to the automobile through the CAN bus to affect a condition of an automotive component.

21. The method of communication of claim 19, wherein the write signal is wirelessly transmitted from the automobile-agnostic mobile device and originates at an automobile-agnostic mobile device application.

22. The method of communication of claim 19, wherein authenticating that the automobile-agnostic mobile device possesses a read privilege comprises determining that the automobile agnostic mobile device has a first authentication level.

23. The method of communication of claim 22, further comprising
determining that another mobile device has a second authentication level; and
giving the other mobile device access to the data signal without conversion to the mobile device format.

24. A computer-readable storage medium having computer-readable instructions stored thereon that are executable by a computing device to perform the method of claim 19.
